(19) United States
(12) Patent Application Publication
(10) Pub. No.: US 2015/0092040 A1
(43) Pub. Date: Apr. 2, 2015

(54) Gesture-Based Industrial Monitoring

(71) Applicant: Broadcom Corporation, Irvine, CA (US)

(72) Inventors: Xuemin Chen, Rancho Santa Fe, CA (US); Yongbum Kim, Los Altos Hills, CA (US)

(73) Assignee: Broadcom Corporation, Irvine, CA (US)

(21) Appl. No.: 14/179,872

(22) Filed: Feb. 13, 2014

Related U.S. Application Data
(60) Provisional application No. 61/926,742, filed on Jan. 13, 2014.
(60) Provisional application No. 61/885,303, filed on Oct. 1, 2013.

(51) Int. Cl. H04N 7/18; G08B 21/18; H04N 5/232

(52) U.S. Cl. CPC H04N 7/183; H04N 5/23212; G08B 21/18
USPC 348/86

(57) ABSTRACT

A system includes an imager, such as a 3-D structured light imaging system, and gesture logic in data communication with the imager. The imager is configured to create an image of the motion of a mobile subject. The gesture logic is configured to: generate a first mapping of the current motion of the mobile subject based on the image, access a stored second mapping of a model gesture, and compare the first mapping to the second mapping to determine a operational condition of the mobile subject.

### 1. PRIORITY CLAIM

This application claims priority to U.S. Provisional Application Ser. No. 61/926,742, filed Jan. 13, 2014, and to U.S. Provisional Application Ser. No. 61/885,303, filed Oct. 1, 2013, which are incorporated herein by reference in their entirety.

### 2. TECHNICAL FIELD

This disclosure relates to automated monitoring. This disclosure also relates monitoring via recognized machine gestures.

### 3. BACKGROUND

Machine vision systems allow for computer controlled visual interaction with a variety of environments. For example, automated piloting of motor vehicles may be possible using machine vision systems. Machine visions systems may use imaging and other visualization technologies, e.g. sonar, radar, sonography, infrared imaging, and/or other visualization technologies. In industrial settings, video monitoring is used to oversee operations and provide safety and security. Human operators may use several view screens to monitor operations at remote locations. The operator may be able to detect improper operation, security breaches, and/or safety issues from the view screens. Remote monitoring via view screen may alleviate the need for in-person monitoring, e.g. on-site or at the point of industrial activity.

### BRIEF DESCRIPTION OF THE DRAWINGS

FIG. 1 shows an example of an environment that implements automated operational monitoring.

FIG. 2 shows example gesture logic.

FIG. 3 shows example gesture recognition scenarios.

FIG. 4 shows and an example structured light imaging process.

### DETAILED DESCRIPTION

Monitoring operations in an industrial environment may be challenging. In some cases, personnel may be used to monitor video feeds and/or directly view equipment and/or other personnel to determine operational status of systems within the industrial environment. In some cases, the monitoring process may involve viewing a repetitive process for extended periods to detect breaks in the repetitions. In some cases, personnel may experience breaks in their attention and events of interest may be missed. For example, a person tasked with monitoring manufacturing device on an assembly line may fall asleep. In some cases, the sleeping person may fail to report a breakdown in a device within a window to avoid a more significant problem (e.g., a line stoppage, etc.). Additionally or alternatively, personnel may be unable to recognize events of interest. For example, a person may view abnormal operation of a device but fail to identify the operation as abnormal. In another example, monitoring personnel may fail to identify a situation in which a person operating a device (e.g. a vehicle and/or heavy machinery, etc.) is not paying attention to their duties. In some cases, it may be advantageous to implement automated techniques for industrial operation monitoring to augment and/or replace monitoring by personnel.

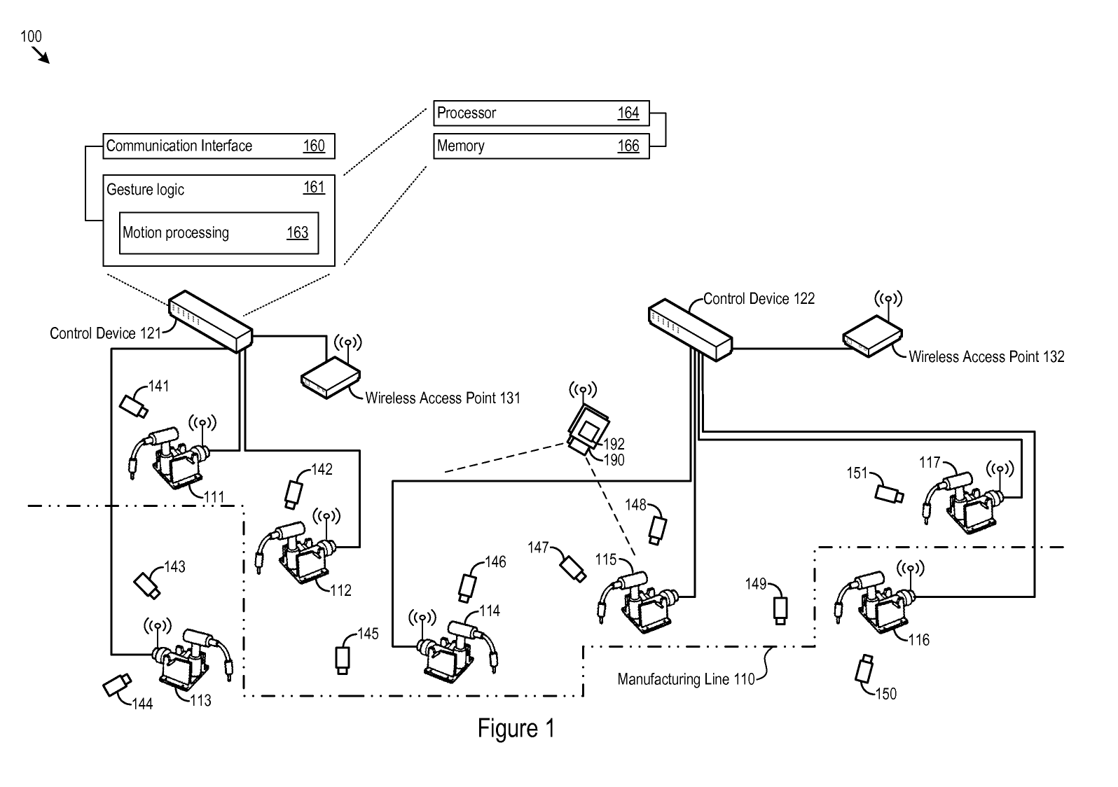

FIG. 1 shows an example of an environment 100 that implements automated operational monitoring. The environment 100 may be any industrial environment, such as a manufacturing assembly line, industrial materials processing plant, or factory inventory area. In particular, the environment 100 shown in FIG. 1 is an industrial environment that includes the manufacturing line 110. The environment 100 is not limited to industrial settings, however, and any environment in which the security feature provisioning discussed below might be useful is a possibility, such as within a vehicle, a hospital, theme park, or prison. For example, failures in monitoring operations at a hospital may result in harm to patients and/or employees.

An environment 100 may include any number of devices. The example industrial environment 100 in FIG. 1 includes manufacturing devices 111-117, control devices 121 and 122, wireless access points (AP) 131 and 132, and multiple sensors labeled as sensors 141-151. Additional or alternative devices may be present in the industrial environment 100, including as examples, network devices such as hubs, switches, routers, or bridges, data servers, actuators, generators, motors, machinery, monitoring devices (such as video cameras or other imagers), light sources, computers, management or control systems, environment management devices, analysis systems, communication devices, and any mobile device such as a mobile phone, tablet, and the like.

The manufacturing devices 111-117 are positioned along the manufacturing line 110. The manufacturing devices 111-117 may be implemented as any machinery, robotics, actuators, tooling, or other electronics that participate in an assembly (or de-assembly) process along the manufacturing line 110. The manufacturing devices 111-117 are communicatively linked to control devices, through which the manufacturing devices 111-117 receive control signals that monitor, guide, or control the manufacturing devices 111-117. In FIG. 1, the control device 121 is communicatively linked to the manufacturing devices 111-113 and the control device 122 is communicatively linked to the manufacturing devices 114-117. In some variations, the control device 112 is a programmable logic controller (PLC).

The sensors 141-151 may monitor various locations in the industrial environment 100. In FIG. 1, the sensors 141-151 are positioned at predetermined monitoring locations along the manufacturing line 110 and proximate to the manufacturing devices 111-117. The sensors 141-151 may capture environment data for monitoring the environment 100, such as visual data, audio data, temperature data, positional or movement data, or any other environment data indicative of a characteristic of the industrial environment 100. The sensors 141-151 may communicate captured data to any device in the industrial environment 100, an analysis system, or a monitoring system. As discussed below, the monitoring system may incorporate gesture recognition to facilitate automated responses to changes in operational status and/or other monitoring initiated responses.

The industrial environment 100 supports multiple communication links between any of the devices within and/or outside the industrial environment 100. The multiple communication links may provide redundancy or failover capabilities between the communicating devices. As one such example shown in FIG. 1, the control device 121 is linked to the manufacturing device 111 through a wired communication path (e.g., through a wired cable) and a wireless communication path (e.g., via the wireless access point 131). The manufacturing devices 111-117, in that regard, may communicate across multiple technologies, including any number of wired technologies and/or wireless technologies. To support the communication links, the control device 121 and manufacturing devices 111-117 may include logic to execute communication protocols and security features. For example, the devices may include master terminal units (MTUs), programmable logic controllers (PLCs), and/or programmable array controllers (PACs). For example, in some implementations, a security feature (e.g. end-to-end encryption) may provide protection on a communication link between an MTU on a controller device and a PLC on a manufacturing device. The communication links may facilitate transfer of images, e.g. video, photographic, sonographic, etc., for processing at control devices or other data processors.

A device in the industrial environment 100 may include a communication interface that supports multiple communication links with other devices within or outside of the industrial environment 100. A communication interface may be configured to communicate according to one or more communication modes, e.g., according to various communication techniques, standards, protocols, or across various networks or topologies. The communication interface may support communication according to particular quality-of-service (QoS) techniques, encoding formats, through various physical (PHY) interfaces, and more. For example, a communication interface may communicate according to any of the following network technologies, topologies, mediums, protocols, or standards: Ethernet including Industrial Ethernet, any open or proprietary industrial communication protocols, cable (e.g. DOCSIS), DSL, Multimedia over Coax Alliance (MoCA), power line (e.g. HomePlug AV), Ethernet Passive Optical Network (EPON), Gigabit Passive Optical Network (GPON), any number of cellular standards (e.g., 2G, 3G, Universal Mobile Telecommunications System (UMTS), GSM (R) Association, Long Term Evolution (LTE) (TM), or more), WiFi (including 802.11 a/b/g/n/ac), WiMAX, Bluetooth, WiGig (e.g., 802.11 ad), and any other wired or wireless technology or protocol. The control device 121, as one example, includes the communication interface 160.

The control device 121 may include gesture logic 161 for processing images to facilitate the gesture recognition techniques discussed below. For example, the gesture logic 161 may include processors 164 (e.g., graphics processing units (GPU), general purpose processors, and/or other processing devices) and memory 166 to analyze recorded images for gesture recognition. In some implementations, an imager 190 (e.g., a 3-D camera, etc.) may include an optical sensor 192 (e.g., a 3-D sensor, etc.) which may capture images of one or more mobile subjects (e.g. manufacturing devices 111-117). The imager may transfer the images (e.g. over a network or within a combined imaging and processing device) to the gesture logic 161. The gesture logic 161 may run motion processing 163 (e.g. gesture recognition middleware, etc.). The motion processing 163 may identify motion within the images and perform comparisons with determined gestures. The motion processing software may determine if the identified motion within the images corresponds to one or more of the determined gestures.

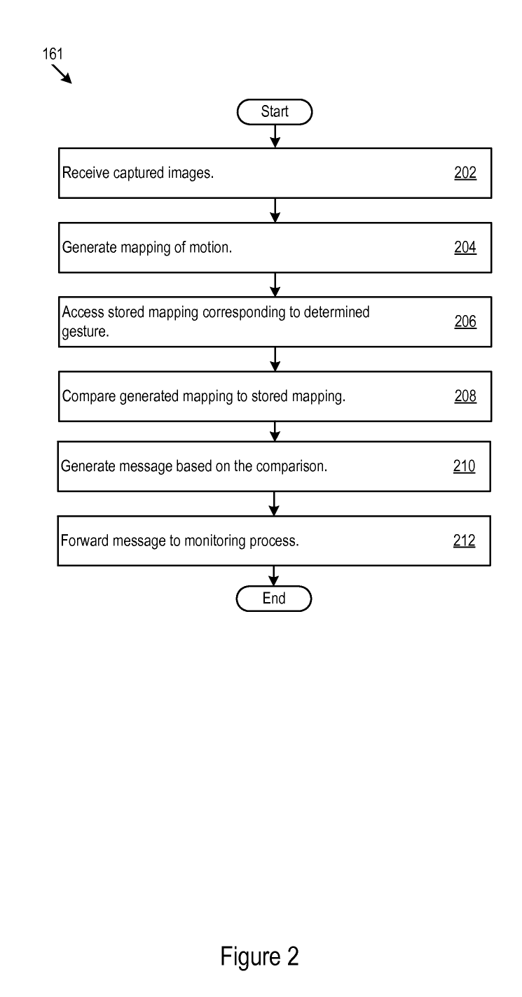

FIG. 2 shows example gesture logic 161. The gesture logic 161 may receive one or more captured images showing the motion of a mobile subject (202). For example, the images may include a live video showing the current motion of a subject. In some implementations, the images may be 3-D images containing data on the position of the mobile subject in 3-D space. The mobile subject may include virtually any object or group of objects in motion, e.g., a person or animal, a machine, an inanimate object being manipulated, etc.

The gesture logic 161 may generate a mapping of the motion of the mobile subject in space (204). For example, the gesture logic 161 may map the motion of the mobile subject to 3-D based on position data in 3-D images. To facilitate mapping of the motion of the mobile subject, the gesture logic 161 may apply the motion processing 163 to the captured images. In various implementations, the motion processing 163 may apply background modeling and subtraction to remove background information in the images. In some implementations, the motion processing 163 may apply feature extraction to determine the bounds on the mobile subject or subjects in the captured images. In some cases, the motion processing 163 may apply pixel processing to ready the captured images for analysis. In some implementations, the motion processing 163 may apply tracking and recognition routines to identify the motion in the captured images that applies to the motion of the one or more mobile subjects being analyzed. For example, background modeling and subtraction may include processes such as, luminance extraction from color images (e.g. YUV:422), calculating running mean and variance (e.g. exponentially-weighted or uniformly-weighted, etc.), statistical background subtraction, mixed Gaussian background subtraction, morphological operations (e.g. erosion, dilation, etc.), connected component labeling, and/or other background modeling and subtraction. In some implementations, feature extraction may include Harris corner score calculation, Hough transformations for lines, histogram calculation (e.g. for integer scalars, multi-dimensional vectors, etc.) Legendre moment calculation, canny edge detection (e.g. by smoothing, gradient calculation, non-maximum suppression, hysteresis, etc.), and/or other feature extraction processes. In various implementations, pixel processing may include color conversion (e.g. YUV:422 to YUV planar, RGB, LAB, HSI, etc.), integral image processing, image pyramid calculation (e.g. 2×2 block averaging, gradient, Gaussian, or other image pyramid calculation), non-maximum suppression (e.g. 3×3, 5×5, 7×7, etc.), first order recursive infinite impulse response filtering, sum-absolute-difference-based disparity for stereo images, and or other pixel processing. In some implementations, tracking and recognition may include Lucas-Kanade feature tracking (e.g. 7×7, etc.), Kalman filtering, Nelder-Mead simplex optimization, Bhattacharya distance calculation, and/or other tracking and recognition processes.

The gesture logic 161 may access one or more stored mappings which may correspond to determined gestures (206). For example, the mapping may include a designation of a series of positions that the mobile subject may travel to complete the gesture. Additionally or alternatively, the mapping may contain relative elements. For example, to complete a given gesture, may move a determined distance to the left from its starting position. The gesture may include movement of determined parts of the mobile subject. For example, the gesture may include a person grasping a lever with their right hand and pulling it down. The gesture mapping may reflect the structure of the mobile subject. For example, the mapping may include movements corresponding to a skeletal frame with joints able to bend in determined ways. The gesture may be included movements for multiple subjects. For example, a gesture may correspond to a coordinated action, such as a handoff of a product between multiple manufacturing devices. The gesture may indicate a time frame or speed for determined movements.

The gesture logic 161 may compare the generated mapping to the one or more mappings of the determined gestures (208). For example, the gesture logic 161 may determine whether the movement of the mobile subject matches the movement defined in the gesture matching to within a determined threshold. In some implementations, the gesture logic 161 may preform transformations on the mapping of the movement of the mobile subject. For example, is some cases, the gesture logic 161 may flip and/or translate the mobile subject mapping if no match is found for the initial mapping. In some cases, the gesture logic 161 may apply the mapping of the mobile subject to a structure (e.g. a skeletal structure) to facilitate comparison with a gesture mapping applied to such a structure. Additionally or alternatively, the comparison may include a determination if the motion of the mobile subject includes travel (or other movement) to absolute locations while not applying transformations. For example, this may be used to ensure a device stays within a determined safe zone and/or picks up material from the correct location during the manufacturing processes. In some cases, the gesture logic 161 may compare the mapped motion of the mobile subject to multiple gesture mapping.

Based on the comparison, the gesture logic 161 may generate a message indicating if a match to a gesture was found for the motion of the mobile subject (210). The gesture logic 161 may forward the message to a monitoring process (212). In some implementations, the monitoring process may run on the gesture logic 161. Additionally or alternatively, the monitoring process may be external to gesture logic 161. For example, the gesture logic 161 may forward a message to an alert system. In some cases, the alert system may generate an alert or activate an alarm in response to a message indicating an event of interest, e.g., if a non-match to desirable gesture and/or a match to an undesirable gesture is found.

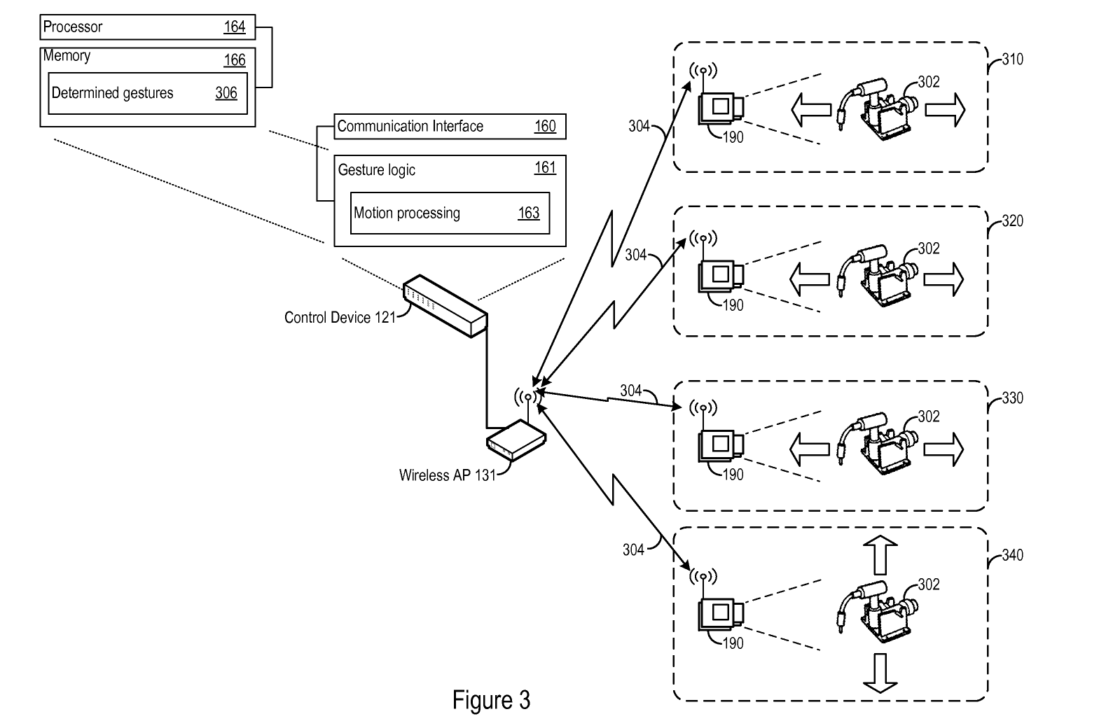

FIG. 3 shows example gesture recognition scenarios 310, 320, 330, 340. In the example scenarios 310, 320, 330, 340, the imager 190 records images of a manufacturing device 302. The imager sends, via a network link 304, the captured images to the control device 121 including gesture logic 161. The gesture logic 161 processes the images for the example scenarios 310, 320, 330, and 340 to identify motion. In the scenarios 310, 320, 330, the motion identified in the captured images corresponds to a first motion sequence (e.g. a horizontal oscillation, etc.). In the scenario 340, the motion identified in the captured image corresponds to a second motion sequence (e.g. a vertical oscillation, etc.) different from the first motion sequence. The gesture logic 161 may access determined gestures 306 for recognition comparison on memory 166. In the example scenarios 310, 320, 330, 340 the determined gestures correspond to the first motion sequence. The gesture logic 161 may respond to identified motion in scenarios 310, 320, 330 by generating a message indicating a match to the recognized gestures. For scenario 340, the gesture logic 161 may respond to the identified motion (e.g. all or a portion of the second motion sequence) by generating a message indicating the identified motion does not match the determined gestures. The example scenarios 310, 320, 330, 340 provide a context for explaining automated monitoring based on gesture recognition. Other subjects, types of motion and gestures (e.g. complex motion sequences, multi-subject sequences, etc.) may be used.

The messages indicating matches or non-matches may be applied in different monitoring processes. For example, the messages may be used to determine the operational status (e.g. normal operation, anomalous operation, etc.) of a device, monitoring personnel (e.g. for attention to job duties, mood, performance, etc.), generating alerts in response to events of interest (e.g. unrecognized gestures, etc.), optimizing assembly line flow, automatically changing monitoring activities in respond to events of interest, and/or other monitoring process activities.

In some cases, automatically changing monitoring activities may include increasing the quality and/or quantity of security video captured. For example a video surveillance system may record video in a first mode (e.g. e.g. low definition video, low frame rate, no audio, and/or grayscale, etc.). In response to a message indicating an event of interest, the video surveillance system may switch to a second mode (e.g. high definition video, high frame rate, audio, and/or color, etc.). In some cases, surveillance video captured prior to the event of interest may be desirable to view in the second mode. In some implementations, video may be captured second mode and then after a delay (e.g. minutes, hours, days, weeks, etc.), compressed to the first mode. In some cases, one or more messages indicating events of interest may cause the system to store the period of surveillance video surrounding the event beyond the delay (e.g. permanently, until reviewed, until deleted by authorized personnel, etc.). Additionally or alternatively, automatically changing monitoring activities may include automatically delivering and/or highlighting surveillance video for onsite or offsite personnel (e.g. for live viewing rather than later review, etc.).

In some implementations, optimizing assembly line flow and/or other work flows may include automatically advancing a queue when a message received by the monitoring process indicates that a task is complete or near completion. For example, a determined gesture may correspond to motion done to perform a task or a motion at a determined point in a task. A monitoring process may be configured to cause a new part to be moved into position to support a next iteration or repetition of a task (e.g. move an assembly line forward, etc.). Additionally or alternatively, flow may be interrupted in response to a gesture. For example, an employ may raise hand to halt an assembly line. In some cases, such as food preparation, such a system may be advantageous because an employee wearing protective gloves may avoid contamination from pressing buttons or making contact with other surfaces to stop the line.

In various implementations, alerts may include alerts such as, an alert to rouse a person whose attention has potentially lapsed, an alert for a technician that an equipment failure may be occurring, an alert that a safety zone has been breached, and/or other alerts.

In some implementations, the gesture based monitoring processes discussed herein may be applied to non-industrial monitoring. For example, in medical applications, gestures may be used to track progress of physical therapy patients, monitor sleep patterns for study (e.g. face strain, rapid eye movement (REM), sleep duration, etc.), monitor therapy application (e.g. drip rates, sensor placement, equipment configuration, etc.), patient condition (e.g. indications of pain, arthritis, stoke (e.g. by asymmetrical facial movement), etc.), and/or other medical monitoring/diagnosis.

In some implementations, 3-D images may be obtained to support the gesture recognition process. Examples of 3-D imagers may include time-of-flight based systems (e.g. radar, sonar, echo-location, lidar, etc.), multiple-senor and/or multiple illumination source systems, scanning systems (e.g. magnetic resonance imaging (MRI), computed tomography scans (CT scans)), structured light systems, coded-light systems, and/or other 3-D imaging systems.

In various implementations, time-of-flight imaging systems operate by sending out a signal in a determined angle or direction and measure the time to reception of a reflection back to the signal source (e.g. a sensor in proximity to (or a determined distance from) the source). The time to reception of reflection may be divided by the speed of the signal sent (e.g. speed of light, speed of sound, etc.). A 3-D image of reflective surfaces surrounding the time-of-flight imager may be generated by scanning a variety of angles and/or directions. In some cases, time-of-flight imagers be associated with challenges such as aliasing (distance ambiguity), motion blur (e.g. for movement faster than the scanning and or source signal interval), resolution, interference (e.g. from similar sources), and/or ambient signals. Time-of-flight systems may offer performance competitive with other 3-D imaging systems in metrics such as, operational range, field of view, image capture (size, resolution, color), frame rate, latency, power consumption, system dimensions, and operation environment. Time-of-flight systems also offer competitive performance in applications such as full-body tracking, multiple body part tracking, and multiple body tracking. However, time-of-fight system cost may provide challenges.

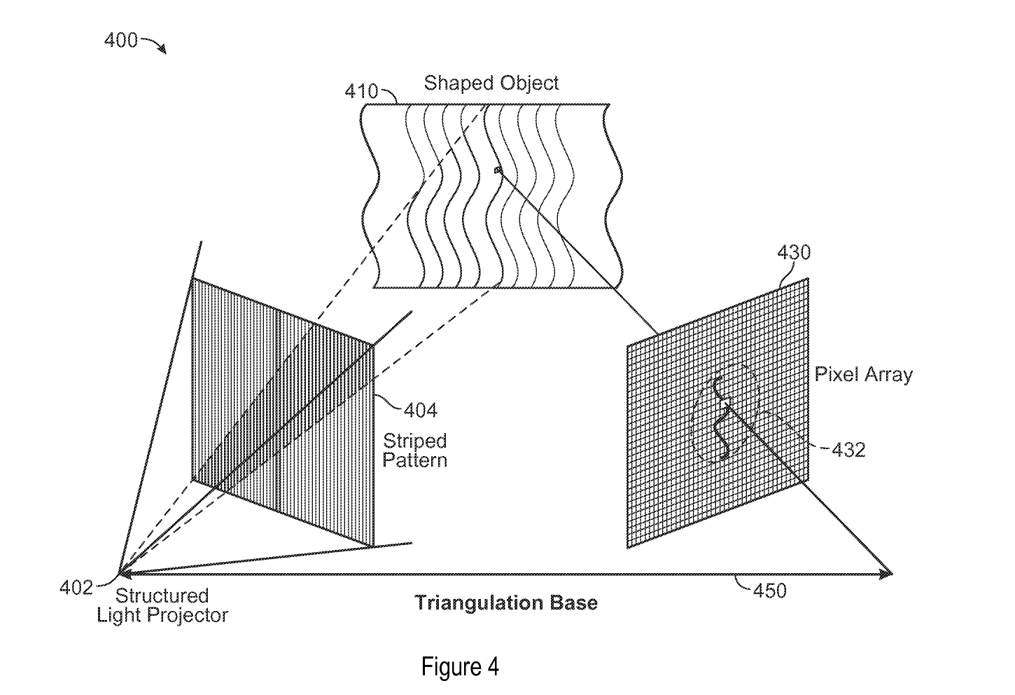

In some implementations, structured light systems project a 2-D light pattern into the imaged 3-D environment to allow for coding the positions of objects in the imaged 3-D environment into the coordinate system of the projector. The structured light system may use triangulation determine the 3-D positions and features of the object illuminated by the structured light source. FIG. 4 shows and an example structured light imaging process 400. A structured light projector 402, providing a striped pattern 404 including stripe 406, illuminates a shaped object 410. The stripe 406 is deformed by the projection onto the shaped object 410. The deformed stripe 432 is captured by a pixel array 430 on a camera. The position of the deformed stripe 432 on the pixel array 434 may be used to map the features and position of the shaped object using triangulation. The triangulation is based on the triangulation base 450 which includes the known distance between the structured light source and the pixel array 434. Structured light systems may offer performance competitive with other 3-D imaging systems in metrics such as, operational range, field of view, image capture (size, resolution, color), frame rate, latency, power consumption, system dimensions, and operation environment. Structured light systems systems also offer competitive performance in applications such as full-body tracking. However, multiple body part tracking and multiple body tracking may provide challenges in structured light systems.

In various implementations, coded light systems may operate on a similar principle to structured light systems. A 2-D light pattern may be projected into the imaged 3-D environment to allow for coding the positions of objects in the imaged 3-D environment into the coordinate system of the projector. The coded light system may use triangulation determine the 3-D positions and features of the object illuminated by the coded light source. A code light system may further time multiplex multiple 2-D patterns for projection. The additional 2-D patterns may allow for increased spatial resolution. For example, positions and features of shaped objects may be triangulated for multiple 2-D patterns and statistical processing may be applied to remove calculation errors. In some cases, motion of an illuminated subject may be blurred at the time scale of the time-multiplexing. Coded-light systems may offer performance competitive with other 3-D imaging systems in metrics such as, operational range, field of view, image capture (size, resolution, color), frame rate, latency, power consumption, system dimensions, and operation environment. Coded-light systems also offer competitive performance in applications such as full-body tracking, multiple body part tracking, and multiple body tracking.

In various implementations, source-based illuminators (e.g. used in time-of-flight, structured-light, coded-light systems, etc.) may contain know properties (e.g. frequency, etc.). Light from sources with differing properties may be ignored. This may aid in background removal. For example, strobing (or other light coding) may be implemented in the source to add a property for discrimination against external light sources. Coded light sources may project known time-division multiplexed patterns. In various implementations, captured image data not found to reflect the time-multiplexed property may be removed to avoid noise from interfering sources.

In some implementations, audio may be captured in the industrial environment. Audio gesture (e.g. determined audio pattern recognition) analysis may be applied to the captured audio. For example, a manufacturing device performing a determined task may generate a recognizable audio pattern. Captured audio may be compared to known patterns to determine operational status. In various implementations, audio gesture analysis may be paired with image gesture analysis. In various implementations, microphone sensors may be distributed in the example industrial environment 100 to facilitate audio gesture analysis.

Additionally or alternatively, the industrial environment 100 may be controlled to minimize interference sources with similar properties to the illumination sources. For example, in a fully automated manufacturing plant lights and other radiation sources may be minimized or eliminated in the absence of personnel using such lights to see. Additionally or alternatively, the illumination source (e.g. code-light sources, structured light sources, time-of-flight sources, etc.) may operate in bands unused by persons or other equipment within the industrial environment 100. For example, the illumination source may operate in the near or far infrared bands which are invisible to humans and may not be used for general purpose lighting.

The methods, devices, and logic described above may be implemented in many different ways in many different combinations of hardware, software or hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various implementations have been described, it will be apparent to those of ordinary skill in the art that many more embodiments and implementations are possible within the scope of the disclosure.

What is claimed is:

1. A system, comprising:
an imager comprising configured to capture a video of a current motion of a manufacturing device; and
logic, in data communication with the imager, the logic configured to:
based on the video, generate a first mapping, in a multi-dimensional space, of the current motion of the manufacturing device;
access a stored second mapping of a model gesture; and
compare the first mapping to the second mapping to determine whether the current motion of the manufacturing device deviates from the model gesture; and
when the current motion of the manufacturing device deviates from the model gesture:
generate a message indicating the deviation; and
send the message to a monitoring process associated with the manufacturing device.

2. The system of claim 1, where:
message is configured to indicate non-compliant operation of the manufacturing device; and
monitoring process is configured to generate an alert on a view screen in response to the message.

3. A system, comprising:
an imager configured to create an image of a current motion of a mobile subject;
logic, in data communication with the imager, the logic configured to:
based on the image, generate a first mapping of the current motion of the mobile subject;
access a stored second mapping of a model gesture; and
compare the first mapping to the second mapping to determine an operational condition of the mobile subject.

4. The system of claim 3, where the imager is configured to create a series of images comprising the image.

5. The system of claim 4, where the first mapping comprises a first video mapping based on the series of images.

6. The system of claim 5, where the model gesture comprises a group of determined motions; and
the second mapping comprises a second video mapping of the group of determined motions.

7. The system of claim 6, where the group of determined motions is associated with a complaint operational status of the mobile subject.

8. The system of claim 6, where the logic is further configured to generate an alert when the comparison indicates that the current motion differs from the group of determined motions.

9. The system of claim 3, where the logic is configured to process the image based on a property of a source.

10. The system of claim 9, where the source comprising a light source; and
the property comprises a code embedded in an output of the light source.

11. The system of claim 3, where the imager comprises:
an optical sensor configured to capture the image; and
a focusing apparatus configured to produce the image on the optical sensor.

12. The system of claim 3, where the first and second mappings comprise mappings in multi-dimensional space.

13. The system of claim 3, where the logic is configured to generate an alert based on the determined operational condition.

14. The system of claim 13, where:
the mobile subject comprises an equipment operator; and
the alert is configured to rouse the equipment operator in response to a potential attention lapse.

15. The system of claim 13, where the alert is configured indicate that the mobile subject has breached a safety zone.

16. A method, comprising:
capturing a video of a current motion of a mobile subject;
based on the video, generating a first mapping of the current motion of the mobile subject;
accessing a stored second mapping of a model gesture; and
comparing the first and second mappings to determine an operational status of the mobile subject.

17. The method of claim 16, further comprising:
selecting the stored second mapping based on a type of the mobile subject and a task scheduled for performance by the mobile subject.

18. The method of claim 17, where determining the operational status comprises determining whether the mobile subject performed the task in a non-compliant manner.

19. The method of claim 18, where a deviation from the model gesture by the mobile subject indicates non-compliant performance.

20. The method of claim 16, where the generating of the first mapping is based on a property of a light source that illuminates the mobile subject.
